(19) United States
(12) Patent Application Publication
(10) Pub. No.: US 2024/0311853 A1
(43) Pub. Date: Sep. 19, 2024

(54) Artificial Intelligence Inventory Management with Regard to Bulk/Bundled Products

(71) Applicant: International Business Machines Corporation, Armonk, NY (US)

(72) Inventors: Randy A. Rendahl, Raleigh, NC (US); Jeremy R. Fox, Georgetown, TX (US); Tushar Agrawal, West Fargo, ND (US); Sarbajit K. Rakshit, Kolkata (IN)

(21) Appl. No.: 18/122,175

(22) Filed: Mar. 16, 2023

(51) Int. Cl. G06Q 30/0202; G06Q 10/087; G06Q 30/0204

(52) U.S. Cl. CPC G06Q 30/0202; G06Q 10/087; G06Q 30/0204

(57) ABSTRACT

Mechanisms are provided for bulk product processing. Product data and customer data are obtained which specify characteristics of products and customer choice characteristics. A knowledge corpus is created based on a historical learning analysis of the product data and customer data, where the knowledge corpus comprises data specifying customer buying patterns, patterns in growing or waning customer interest in products, and patterns in customer choice of products for purchase. An artificial intelligence (AI) computer pipeline executes an AI computer model on the knowledge corpus to predict, for a customer segment of the customer data, a product that customers will purchase in bulk. A bulk product recommendation is generated based on results of executing the AI computer model and output to a product provider computing system.

### BACKGROUND

The present application relates generally to an improved data processing apparatus and method and more specifically to an improved computing tool and improved computing tool operations/functionality for performing inventory management, and specifically with regard to product bundles, based on artificial intelligence (AI) computer model decision support.

The ability of manage product inventories and achieve maximum profits based on these inventories is a concern for product suppliers and retailers. This can be a very difficult task when one takes into account the vast variety of products that suppliers and retailers provide, the trends in product purchasing, the seasonality of such product purchasing, variety in pricing across retailers, and a plethora of other factors that make product inventory based decision making a difficult task to achieve manually or mentally, especially with the rise of electronic commerce and the fact that competition and customer base are expanded to a global scale rather than the local scale of traditional retailer establishments, i.e., “mom-and-pop” stores.

Adding to the complexity of such decision making is the ability for retailers to sell products in bulk or as individual units. Bulk selling means that multiple products of the same category or different categories are sold at the same time to a customer. Such bulk sales are attractive to customers because they typically are given a reduced per unit price as an incentive to purchase in bulk. Such bulk sales are attractive to suppliers and retailers because they move inventory while still providing a profit, even if that profit is not as much on a per unit basis as individual sales. Thus, with bulk sales, inventory removal rates are higher, while the unit price is lower, and with individual sales, inventory removal rates are lower, while the unit price is higher. However, it should be appreciated that not every customer will want to perform bulk purchases and may instead want to engage in individual product sales, i.e., the customer may be of the opinion “I don't need 9, I only need 1.”

Thus, it is difficult to determine if, and when, to perform bulk sales of the same or mixed products, what products to combine into a bulk or bundled sale, who to market such bulk sales to, what pricing to apply to the bulk sales, etc., to try to move inventory while maximizing profits.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a computer-implemented method is provided for bulk product processing. The method comprises obtaining, from at least one product provider computing system, product data specifying characteristics of at least one product, and obtaining, from at least one social media computing system, customer data specifying customer choice characteristics of one or more customers, with regard to purchasing products as indicated in electronic communications associated with the one or more customers. The method further comprises creating a knowledge corpus based on a historical learning analysis of the product data and customer data, where the knowledge corpus comprises data specifying customer buying patterns, patterns in growing or waning customer interest in products, and patterns in customer choice of products for purchase. The method also comprises executing, by an artificial intelligence (AI) computer pipeline comprising a plurality of machine learning trained AI computer models, at least one AI computer model, of the plurality of machine learning trained AI computer models, on the knowledge corpus to predict, for a customer segment of the customer data, at least one product that customers of the customer segment are predicted to purchase in bulk. In addition, the method comprises generating a bulk product recommendation based on results of executing the at least one AI computer model, where the bulk product recommendation specifies the at least one product to be sold in bulk, and outputting the bulk product recommendation to a product provider computing system.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is a high level process flow diagram illustrating an overall process flow for an artificial intelligence (AI) based product inventory management system in accordance with one illustrative embodiment;

FIG. 2 is an example block diagram illustrating the primary operational components of an AI based product inventory management system in accordance with one illustrative embodiment;

FIG. 3 is a flowchart outlining an operation of first stage logic of a product bulk/bundle recommendation engine based on predictions/classifications from AI computer models in accordance with one illustrative embodiment;

FIG. 4 is a flowchart outlining an operation of second stage logic of a product bulk/bundle recommendation engine based on predictions/classifications from AI computer models in accordance with one illustrative embodiment;

FIG. 5 is a flowchart outlining an operation of third stage logic of a product bulk/bundle recommendation engine based on predictions/classifications from AI computer models in accordance with one illustrative embodiment;

FIG. 6 is a flowchart outlining an operation of fourth stage logic of a product bulk/bundle recommendation engine based on predictions/classifications from AI computer models in accordance with one illustrative embodiment;

FIG. 7 is a flowchart outlining an operation of fifth stage logic of a product bulk/bundle recommendation engine based on predictions/classifications from AI computer models in accordance with one illustrative embodiment;

FIG. 8 is a flowchart outlining an operation of sixth stage logic of a product bulk/bundle recommendation engine based on predictions/classifications from AI computer models in accordance with one illustrative embodiment; and

FIG. 9 is an example diagram of a distributed data processing system environment in which aspects of the illustrative embodiments may be implemented and at least some of the computer code involved in performing the inventive methods may be executed.

### DETAILED DESCRIPTION

As noted above, it is a difficult task for suppliers and retailers to determine bulk/bundled sale opportunities, especially given modern electronic commerce in which there may be different types of products available from a large number of suppliers and retailers and these products can have different temporal characteristics, e.g., best use dates, expiry dates, seasonality, purchase trends, pricing, etc. which vary over time. It would be beneficial to have an automated improved computing tool and improved computing tool functionality/operations that leverage artificial intelligence mechanisms, such as historical learning or machine learning, to provide decision support with regard to identifying which products can be sold in different levels of bulk and/or bundled selling opportunities so as to optimize inventory carrying costs and maximize profitability.

The illustrative embodiments provide an improved computing tool and improved computing tool functionality that implements a plurality of artificial intelligence (AI) computer models that are trained through machine learning processes to make various predictions regarding product sales opportunities, and especially with regard to bulk or bundled sales. Bulk sales refers to a plurality of products beings sold together at the same time to a customer, e.g., 5 toothpaste tubes, where these products may be of the same or different types or classifications. Bundled sales may be synonymous to bulk sales, or may be considered a subset of bulk sales, specifically directed to a plurality of different types of products or products having different classifications being sold at the same time to a customer, e.g., shower gel and a loofah sponge, toothpaste and toothbrushes, etc. While the products may be related to one another in bundled sales, such as in these previous examples, because customers tend to want to buy bundled products that address a common situation or issue, having a relationship is not a requirement for bundled sales, e.g., one may bundle chocolate treats with a tool set. For purposes of the present description, the terms “bulk” and “bundled” will be used interchangeably hereafter to reference sales opportunities involving a plurality of product units, which may be of the same or different types/classifications.

It should be appreciated that the illustrative embodiments operate based on a plurality of AI computer models trained to recognize patterns in input features (which may be extracted or generated based on raw data inputs) and generate predictions based on the recognized patterns in the input features. That is, the AI computer models of the illustrative embodiments take a large amount of different types of input data, extract specific features for use by the specific different AI computer models, and generate predictions based on the patterns present in the extracted features and the trained recognition of correlations between these patterns and specific predictions. The amount of input data, and variety of input data, that the AI computer models are able to process, as well as the complexity of the patterns recognized, is beyond the capabilities of mental processes or human activity to evaluate with any expected level of accuracy or practical efficiency. Thus, because of the sheer volume and variety of information, and complexity of the relationships between the different information, if attempted through mental or manual means, human beings resort to mere guesswork which often results in erroneous decision making and lost opportunities. Thus, there is a need for an artificial intelligence/cognitive computing tool, which can leverage the capabilities of such artificial intelligence to achieve what a human being practically cannot. The illustrative embodiments are directed to such an improved artificial intelligence computing system and are not directed to any manual process or mental process performed by a human being.

It should be appreciated that while the illustrative embodiments implement AI computing models and AI computing systems, the purpose of these AI computing models and AI computing systems is to augment, not replace, human intelligence. These AI mechanisms are designed to enhance and extend human potential and capabilities through specific improved computer tools and improved computer tool functionality/operations. These improved computer tools perform operations at a speed, complexity, and volume that is not practically able to be performed by human intelligence. Overall, the illustrative embodiments provide an improved artificial intelligence (AI) computer pipeline comprising a plurality of specifically configured and trained AI computer tools, e.g., neural networks, cognitive computing systems, or other AI mechanisms that are trained based on a finite set of data, i.e., training data, to perform specific tasks for a larger new set of data. In general, these AI computer tools employ machine learning (ML)/deep learning (DL) computer models (or simply ML models) to perform tasks that, while emulating human thought processes with regard to the results generated, use different computer processes, specific to computer tools and specifically ML/DL computer models, which learn patterns and relationships between data that are representative of particular results, e.g., classifications or labels, data values, recommendations, etc.

The ML/DL computer model is essentially a function of elements including the machine learning algorithm(s), configuration settings of the machine learning algorithm(s), features of input data identified by the ML/DL computer model, and the labels (or outputs) generated by the ML/DL computer model. By specifically tuning the function of these elements through a machine learning process, a specific ML/DL computer model instance is generated. Different ML models may be specifically configured and trained to perform different AI functions with regard to the same or different input data.

As the artificial intelligence (AI) pipeline implements a plurality of ML/DL computer models, it should be appreciated that these ML/DL computer models are trained through ML/DL processes for specific purposes. Thus, as an overview of the ML/DL computer model training processes, it should be appreciated that machine learning is concerned with the design and the development of techniques that take as input empirical data (such as product and/or sales data), and recognizes complex patterns in the input data. One common pattern among machine learning techniques is the use of an underlying computer model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used to classify new data points. M may be a statistical model, and the cost function is inversely proportional to the likelihood of M, given the input data. This is just a simple example to provide a general explanation of machine learning training and other types of machine learning using different patterns, cost (or loss) functions, and optimizations may be used with the mechanisms of the illustrative embodiments without departing from the spirit and scope of the present invention.

As noted above, the artificial intelligence (AI) pipeline of the illustrative embodiments generally includes machine learning (ML) and/or deep learning (DL) computer models. Examples of ML/DL computer models that may be implemented in the illustrative embodiments include Bayes Decision computer models, Regression computer models, Decision Trees/Forests computer models, Support Vector Machines computer models, or Neural Networks computer models, among others.

Deep learning can be based on deep neural networks and can use multiple layers, such as convolution layers. Deep learning computer models, such as using layered neural networks, can be efficient in their implementation and can provide enhanced accuracy relative to other ML techniques. In the context of the illustrative embodiments, references herein to one or the other of ML and DL can be understood to encompass one or both forms of AI processing.

The AI pipeline of the illustrative embodiments provides trained AI computer models, trained through machine learning processes, that perform specific pattern recognition and generate corresponding predictions/classifications based on these recognized patterns with regard to product and customer data of various types, so as to identify bundled or bulk product sales opportunities and generate recommendations regarding such bundled/bulk product sales. For example, the AI computer models of the illustrative embodiments predict which product units, out of available inventory, can be created as a bulk sale option versus being sold individually. The AI computer models of the illustrative embodiments also identify what the bulk size and product mix (units from the inventory) should be and recommend the price of each set of bulk product units to maximize profit in the shortest amount of time. The AI pipeline of the illustrative embodiments generates predictions, recommendations, and creates bulk size offerings based on customer base, type of products, and patterns of previous purchases. These predictions of products to be sold in bulk and the bulk size are dynamic over time, and may be determined based on evaluations of how soon the inventory should be sold out based on inventory attributes. In some illustrative embodiments, the results generated by the AI pipeline may be serve as a basis for dynamically creating temporal social network channels to market the bulk/bundled combinations.

The AI computer models of the AI pipeline utilize historical learning based analysis and machine learning training based on historical data to configure the AI computer models to perform predictions and classifications. As an initial element of historical learning and machine learning training, historical data is collected for customers and products from various sources including social networking and/or collaboration websites, instant communication services, commercial websites, inventory control systems, retail computer systems, and the like, data is collected into one or more customer historical databases and one or more product historical data databases. This data is used to train the various ML/DL computer models to make corresponding predictions that support various operations of a product bulk/bundle recommendation system. The product bulk/bundle recommendation system may have multiple stages of operation which utilize the various trained ML/DL computer models.

For example, in a first stage, current customer and product historical data is gathered for use as input to the trained ML/DL computer models. The data collected as part of this first stage of operation may be similar to the data collected as historical data for machine learning training of the AI computer models, but may be during a more recent or current time frame. The collected data may be used as input to the various trained AI computer models to generate predictions.

In a second stage of operation, the product bulk/bundle recommendation system performs a social collaboration engagement analysis that analyzes social media, networking, and/or collaboration platforms to collect customer choice data over time, product purchase data, and predict customer interest trends, e.g., whether customers are losing, maintaining, or increasing interest in particular products, and further predict temporal factors for bulk/bundle sales of the products, e.g., how much time will be needed to sell products that are losing customer interest, such as based on an amount of product in inventory, a trend in number of sales of the product over time, and a trend in the customer interest level.

In a third stage of operation, a knowledge corpus is created based on the data collected during the first stage operation. The creation of the knowledge corpus may include segmentation of customers and correlation of the customer segments with product purchasing patterns to thereby identify which customers are more likely to purchase certain products in bulk, and which products are more likely to be bought by customers in bulk. The knowledge corpus creation may further include determinations of inventory carrying costs of products, expiration dates, spoilage rates, and the like. The created knowledge corpus may further include the trends in customer interest and the temporal factors determined by the second stage of operation. This data may be used by the various AI computer models to make predictions with regard to which products are candidates for bulk/bundled sales based on customer interest level, inventory carrying costs, and temporal factors.

In a fourth stage of operation, the product bulk/bundle recommendation engine projects customer choices to identify products for bulk/bundled selling, when to execute bulk/bundled sales, and drives social media, networking, or collaboration campaigns to promote these bulk/bundled selling opportunities. In this fourth stage, the AI computer models operate on the collected data, the knowledge corpus, and the like, to segment the products based on customer purchase patterns and trends to determine which products and customers are more likely to buy in bulk, and which products are best suited for bulk sales. The product bulk/bundle recommendation engine uses the customer interest information to identify when customer interest levels are likely to fall and determine bulk/bundled sales opportunities based on this predicted level of interest waning. The temporal aspects may further be influenced by the inventory carrying costs, which may include evaluation of product expiration dates, spoilage rates, and the like. Based on the purchase patterns and determined trends, recommendations as to timing of the bulk/bundled sales may be generated. Social media, network, and/or collaboration campaigns may be recommended and/or generated to promote the new bulk/bundled offers, which may involve using social media to advertise the bulk/bundled offers so as to reach potential customers.

In a fifth stage of operation, the product bulk/bundle recommendation engine operates to perform geographic location and mapping expectation predictions. That is, the product bulk/bundle recommendation engine identifies customer locations, product locations, and uses a mapping tool to determine routing for the product to be provided to the customer based on their relative locations. This provides a prediction of estimated time and cost for shipping of the product, estimated transportation costs, and other costs for the delivery of the product to the customer, which maybe used to determine pricing of the product as part of the bulk/bundled sale.

In a sixth stage of operation, the product bulk/bundle recommendation engine operates to determine the expansion/contraction of the geographical reach for bulk/bundled product sales based on live inventory. In this sixth stage of operation, the product bulk/bundle recommendation engine identifies regional retail establishments that need to execute bulk/bundled product sales in order to push their inventory at a lower price due to their current inventory levels, taking into account the expiration dates, processing requirements, spoilage, etc. For retail establishments that need to execute such bulk/bundled product sales, predictions regarding additional staffing and space may be determined.

In each of the stages of operation discussed above, it should be appreciated that monitoring of inventories of products and customer interest is performed over time and dynamic adjustments to the predictions may be made to ensure that the recommendations are up-to-date. Thus, periodically, the data collection and predictions of the various stages of operation based on the AI computer models may be executed so as to use the most current data to generate updated predictions and recommendations.

The recommendations generated by the product bulk/bundle recommendation engine may be provided to product providers, retailers, inventory control systems, or the like, as outputs that may be used to adjust the operation of these various entities. For example, the product bulk/bundle recommendation engine may generate recommendations for bulk/bundle product sales and send these recommendations to a computing system of a specific retailer that sells the product(s), informing the retailer of the need to offer the product(s) as a bulk/bundle sale, the price recommended for the bulk/bundle sale, the recommended timing of the bulk/bundle sale, and the particular customer segment(s) to market the bulk/bundled sale via one or more social media, networking, or collaboration platforms. In some illustrative embodiments, the output from the product bulk/bundle recommendation engine may drive automated operations of the receiving computing systems to modify offerings of the product(s) via an associated website or inventory control system, such as by automatically generating a new bulk/bundled sale entry in the system with corresponding temporal information as to when the price and quantity of the product(s) will be changed and what they will be changed to.

As noted above, the AI pipeline comprises a plurality of ML/DL computer models, referred to collectively herein as AI computer models, which are trained through machine learning processes to make predictions based on patterns in input data, such as customer/product data. In a first AI computer model of the AI pipeline, the illustrative embodiments predict product units to be sold in inventory and provide bundling optimization. That is, based on available products in a retailer facility, as determined through interfacing with inventory control computing systems of the retailer and using unique product identifiers, such as SKUs and the like, the first AI computer model predicts which product units out of available inventory should be sold in bulk and which products can be sold individually so that, aggregated profit with the product inventory, i.e., across all products in the retailer's inventory, is maximized. The first AI computer model predicts the units to be sold in inventory based on input data specifying the products available in the retailer's inventory, the sales price of the products, the cost of the products, the number of products available in the inventory, and the demand for the products.

In a second AI computer model, the size and product mix for a bundle is predicted and a recommended price of each bundle of products, number of each product in the bundle, etc. are determined so as to identify the size and product mix that results in the bulk products being sold within a shortest possible time while maximizing profitability. The second AI computer model receives input data which may include the size of the bundle, the product mix in the bundle, the price of each product in the bundle, and the number of each product in the bundle.

A third AI computer model operates to generate the various sizes of bulk packaging and dynamically determines the different levels of bulk size, e.g., 9 products, 20 products, etc., for different clusters of customers Based on the predicted customer base. In order to generate the various sizes of bulk packaging, the third AI computer model receives data on the customer clusters and the predicted customer base, as well as the types of products being packaged and the quantities of each product.

A fourth AI computer model operates to determine when to initiate the bulk packaging process. That is, based on historical learning, the fourth AI computer model identifies when the bulk selling of different products is to be initiated, where different levels of bulk size can be initiated at different points in time for the same product or combination of products. For example, the fourth AI computer model may determine when to change a bulk size from 9 products to 90 products. In order to make such determinations, the fourth AI computer model operates on a list of products that are eligible for bulk packaging, the quantity of each product that is required for bulk packaging, and the timeframe in which the bulk packaging process should be initiated.

A fifth AI computer model operates to perform social collaboration propagation for bulk processing. That is, based on identified different levels of bulk size for the same or different types of products in each bundle, the fifth AI computer model dynamically propagates the bulk size availability in social networking websites and creates a temporary social network channel so that the bulk sale of products can be sold quickly with the help of the creation of temporary social networking content.

A sixth AI computer model operates to generate predictions regarding mixing and matching of products in bulk or bundles so as to achieve an aggregate volume growth. That is, the sixth AI computer model predicts if bulk products can be associated with individual products so that both the individual products and different level of bulk products can be sold together, while ensuring maximum profit with the identified context. The sixth AI computer model operates on individual product sales data, bulk product sales data, and product association data.

A seventh AI computer model operates to generate a level of interest estimation and predicts this level of interest of customers to buy bulk products. The seventh AI computer model further operates to identify an appropriate supply chain route so that bulk products can be sold within a shortest possible time. The seventh AI computer model operates on such input data as product type, supply chain route information, and customer level of interest as defined by daily hits from social media, for example.

With the above overview of the AI computer models that together make up the AI pipeline of an AI based product inventory management system. The AI computer models generate predictions and classifications for products, specifically with regard to bundling products for bulk sales, so as to maximize movement of products from inventory while also maximizing profits to the suppliers and retailers. The AI pipeline provides one or more outputs, such as dashboard user interfaces and the like, to provide decision support information to users, e.g., subject matter experts (SMEs), so that they can make decisions regarding bulk/bundled sales opportunities and initiate operations to take advantage of such opportunities. In some illustrative embodiments, automated processes may be automatically initiated to facilitate such bulk/bundled sales including creation of social networking channels, social networking content, and distribution of such content to social networking websites for promoting such bulk/bundled sales, as well as scheduling quantity and price changes in inventory control systems, website content control computing systems, or the like.

As an example operation of the AI pipeline and AI computer models of an AI based product inventory management system, consider that the AI pipeline receives input data from one or more suppliers/retailers regarding one or more products of interest. For example, this input data may include product information such as a product SKU, lot number, the price of the product, various date related information, such as expiry date, best use date, etc. In addition, the AI pipeline may receive data based on social media analysis. The social media analysis results data is further analyzed to identify changes in the trends of customer choice over a period of a time and determines if the available products in a supplier/retailer's inventory will be impacted. With regard to new product arrivals, the AI pipeline identifies any new arrival of products and, based on historical learning, identifies if customer level of interest will be reduced for existing products and/or increased for the new products over time.

The AI pipeline of the illustrative embodiments, for each customer, gathers historical purchase pattern information for different products, again identified by their unique identifiers, such as SKUs and the like, as discussed above, and further obtains information regarding their change in choice of products over time. From this information, the AI pipeline predicts how product purchases will be impacted by this change in choice and the purchase patterns. That is, based on historical learning, the AI pipeline determines when the customer will be losing interest in products based on their past behavior, which products will be maintaining interest by the customer based on their past behavior, and how much additional time will be required to sell those products for which the customer is losing interest. From this information, predictions of which products can be sold in bulk or bundled together, what the pricing should be, and what the temporal factors should be for offering the bulk/bundled sales, as well as to which segments of customers such bulk/bundled sales should be marketed. Moreover, in some illustrative embodiments, the particular retail locations that need to offer such bulk/bundled sales may be predicted based on current inventory levels.

Thus, the illustrative embodiments provide an improved computing tool and computing tool operations for determining bulk/bundled product sales opportunities based on artificial intelligence and machine learning/deep learning computer model analysis of trends and patterns in customer and product data over time. The improved computing tool and improved computing tool operation improve profitability of organizations as well as value to customers for products over their lifetime with regard to a large number of influential factors that cannot be practically evaluated in total by human beings. Thus, where human beings will make errors due to their inherent limitations, the artificial intelligence mechanisms of the illustrative embodiments are capable of identifying patterns and trends in large volumes of historical and current customer and product data to generate more accurate predictions and temporal determinations of bulk/bundled product sales opportunities that maximize profitability and customer satisfaction and interest over time.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

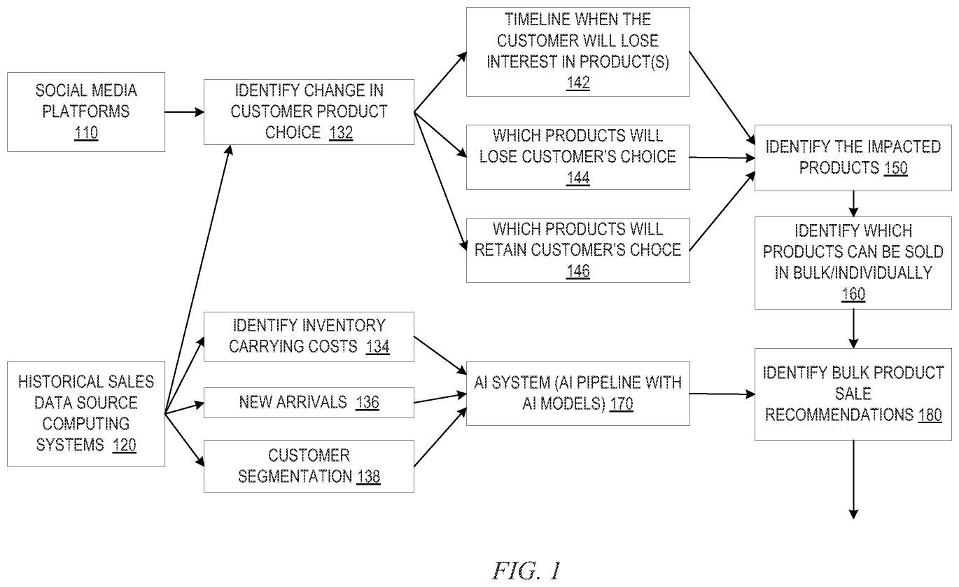

FIG. 1 is a high level process flow diagram illustrating an overall process flow for an artificial intelligence (AI) based product inventory management system in accordance with one illustrative embodiment. As shown in FIG. 1, social media, networking, or collaboration platforms 110 and historical data source computing systems 120 provide data that is analyzed to identify changes or trends in customer product choice over time 132, inventory carrying costs 134 for various products, new product arrivals 136, and customer segmentations 138 based on customer attributes, e.g., geographical region, demographics, economic information, and the like. The identification of changes in customer product choice over time may be used to determine a timeline of when customers will lose interest in a given product 142, which products will lose customer choice 144, and which products will retain customer choice 146. This information to identify the impacted products 150 and which products can be sold individually and in bulk/bundles 160. The product information 142-146 and data 134-138 may be input to the AI system 170 of the illustrative embodiments which generates predictions and classifications that are combined with the identification of individual/bulk/bundled products to identify how the bulk/bundled product sale opportunity is to be generated and bulk/bundled product sale recommendations 180.

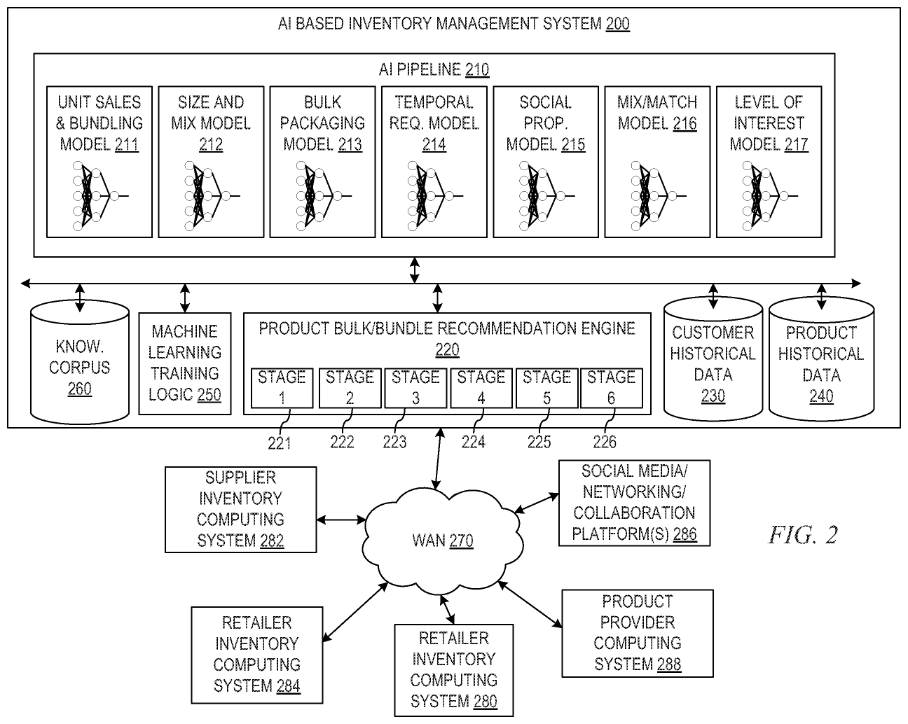

FIG. 2 is an example block diagram illustrating the primary operational components of an AI based product inventory management system in accordance with one illustrative embodiment. As shown in FIG. 2, the AI based inventor management system 200 includes AI pipeline 210 comprising a plurality of machine learning trained AI computer models 211-217, each of which are trained by machine learning training logic 250 to perform different predictions and classifications of customer and product data with regard to recognized trends and patterns in input data. During machine learning training, the input data may come from customer historical data database 230 and product historical data database 240, for example, which may be collected from various historical and social media data source computing systems 280-288. During runtime operation, the input data may come from current collected data, e.g., current within a given relatively smaller time window from a present time, such as within the last 30 days as opposed to historical data which may be over the past 2 years, which is compiled into a knowledge corpus 260.

The AI computer models 211-217 of the AI pipeline 210 may be utilized by logic of the product bulk/bundle recommendation engine 220 to perform predictions and classifications upon which the logic operates to make determinations and recommendations based on these predictions and classifications. For example, the product bulk/bundle recommendation engine 220 may comprise multiple stages of logic, e.g., stages 1-6, referenced as stage logic 221-226, which may each employ one or more of the AI computer models 211-217 to make their evaluations, determinations, and recommendations. The combination of results generated from the stage logic 221-226 may be used to generate one or more product bulk/bundle recommendations that may be output to one or more of the computing systems 282-288, e.g., retailer computing system 280, supplier inventory computing system 282, retailer inventory computing systems 284, social media, networking, and/or collaboration platforms 286, and product provider computing system 288.

As noted previously, the AI computer models 211-217 of the AI pipeline 210 utilize historical learning based analysis and machine learning training based on historical data, such as via the machine learning training logic 250 which may utilize supervised or unsupervised machine learning, linear regression, and the like, to configure the AI computer models 211-217 to perform predictions and classifications. The AI computer models 211-217 may generate outputs which may be binary classifications, vector outputs with vector slots and real values in each slot corresponding to classifications, predictions, or the like. Various ones of the stage logic 221-226 may invoke a given one of the AI computer models 211-217 to obtain a prediction/classification based on its previous training, and processing of current input data from the knowledge corpus 260.

As an initial element of historical learning and machine learning training, historical data 230, 240 is collected for customers and products from various sources including social networking and/or collaboration websites, instant communication services, commercial websites, inventory control systems, retail computer systems, and the like, e.g., 280-288. The data is collected into one or more customer historical databases 230 and one or more product historical data databases 240. This data is used by the machine learning training logic 250 to train the various AI computer models 211-217 to make corresponding predictions that support various operations of the stage logic 221-226 of the product bulk/bundle recommendation engine 220. It should be appreciated that while the various stage logic 221-226 will be references as “first”, “second”, etc., this is not to imply any required ordering of the stage logic 221-226 operations. To the contrary, the stage logic 221-226 may be implemented in any order suitable to the particular implementation. In general, the stage logic 221-226 will be implemented using various ones of the AI computer models 211-217 which operate on input data from the knowledge corpus 260 and thus, collection of data into the knowledge corpus 260 will be performed prior to the operation of the other stage logic 221-226.

For example, in first stage logic 221, current customer and product historical data is gathered for use as input to the trained ML/DL computer models 211-217. The data collected as part of this first stage logic 221 operation may be similar to the data collected as historical data 230, 240 for machine learning training of the AI computer models, but may be during a more recent or current time frame, e.g., within the last 30 days, last 6 months, etc. The collected data may be used as input to the various trained AI computer models 211-217 to generate predictions.

In a second stage logic 222 operation, the product bulk/bundle recommendation system 220 performs a social collaboration engagement analysis that analyzes social media, networking, and/or collaboration platforms 286 to collect customer choice data over time, product purchase data, and predict customer interest trends, e.g., whether customers are losing, maintaining, or increasing interest in particular products, such as by invoking the level of interest AI computer model 217. The second stage logic 222 may further invoke temporal requirements AI computer model 214 to predict temporal factors for bulk/bundle sales of the products, e.g., how much time will be needed to sell products that are losing customer interest, such as based on an amount of product in inventory, a trend in number of sales of the product over time, and a trend in the customer interest level.

In a third stage logic 223 operation, a knowledge corpus 260 is created based on various collected data, such as the data collected during the first stage logic 221 operation. The creation of the knowledge corpus 260 may include segmentation of customers and correlation of the customer segments with product purchasing patterns to thereby identify which customers are more likely to purchase certain products in bulk, and which products are more likely to be bought by customers in bulk. The knowledge corpus 260 creation may further include determinations of inventory carrying costs of products, expiration dates, spoilage rates, and the like. The created knowledge corpus 260 may further include the trends in customer interest and the temporal factors determined by the second stage logic 222 operation. This data may be used by the various AI computer models 211-217 to make predictions with regard to which products are candidates for bulk/bundled sales based on customer interest level, inventory carrying costs, and temporal factors.

In a fourth stage logic 224 operation, the product bulk/bundle recommendation engine 220 projects customer choices to identify products for bulk/bundled selling, e.g., using AI computer models 211-213, when to execute bulk/bundled sales, e.g., using AI computer model 214, and drives social media, networking, or collaboration campaigns to promote these bulk/bundled selling opportunities, e.g., using AI computer model 215. In this fourth stage logic 224, the AI computer models 211-217 operate on the collected data, e.g., the knowledge corpus 260, and the like, to segment the products based on customer purchase patterns and trends to determine which products and customers are more likely to buy in bulk, and which products are best suited for bulk sales. The product bulk/bundle recommendation engine 220 uses the customer interest information to identify when customer interest levels are likely to fall and determine bulk/bundled sales opportunities based on this predicted level of interest waning. The temporal aspects may further be influenced by the inventory carrying costs, which may include evaluation of product expiration dates, spoilage rates, and the like. Based on the purchase patterns and determined trends, recommendations as to timing of the bulk/bundled sales may be generated. Social media, network, and/or collaboration campaigns may be recommended and/or generated to promote the new bulk/bundled offers, which may involve using social media to advertise the bulk/bundled offers so as to reach potential customers.

In a fifth stage logic 225 operation, the product bulk/bundle recommendation engine 220 operates to perform geographic location and mapping expectation predictions. That is, the product bulk/bundle recommendation engine 220 identifies customer locations, product locations, and uses a mapping tool to determine routing for the product to be provided to the customer based on their relative locations. This provides a prediction of estimated time and cost for shipping of the product, estimated transportation costs, and other costs for the delivery of the product to the customer, which may be used to determine pricing of the product as part of the bulk/bundled sale.

In a sixth stage logic 226 operation, the product bulk/bundle recommendation engine 220 operates to determine the expansion/contraction of the geographical reach for bulk/bundled product sales based on live inventory. In this sixth stage logic 226 operation, the product bulk/bundle recommendation engine 220 identifies regional retail establishments, e.g., retailer corresponding to retailer inventor computing system 280, that need to execute bulk/bundled product sales in order to push their inventory at a lower price due to their current inventory levels, taking into account the expiration dates, processing requirements, spoilage, etc. For retail establishments that need to execute such bulk/bundled product sales, predictions regarding additional staffing and space may be determined.

In each of the stage logic 221-226 operations discussed above, it should be appreciated that monitoring of inventories of products and customer interest is performed over time and dynamic adjustments to the predictions may be made to ensure that the recommendations are up-to-date. Thus, periodically, the data collection and predictions of the various stage logic 221-226 operations, based on the AI computer models 211-217, may be executed so as to use the most current data to generate updated predictions and recommendations.

The product bulk/bundle recommendation engine 220 combines the results of the various stage logic 221-226 determinations to generate a product bulk/bundle sale recommendation that may specify the product(s) for bulk/bundle sale and the terms and timing for the bulk/bundle sale. The recommendations generated by the product bulk/bundle recommendation engine 220 may be provided to product providers, retailers, inventory control systems, or the like, e.g., systems 280-288, as outputs that may be used to adjust the operation of these various entities. For example, the product bulk/bundle recommendation engine 220 may generate recommendations for bulk/bundle product sales and send these recommendations to a computing system 280 of a specific retailer that sells the product(s), informing the retailer of the need to offer the product(s) as a bulk/bundle sale, the price recommended for the bulk/bundle sale, the recommended timing of the bulk/bundle sale, and the particular customer segment(s) to market the bulk/bundled sale via one or more social media, networking, or collaboration platforms. In some illustrative embodiments, the output from the product bulk/bundle recommendation engine 220 may drive automated operations of the receiving computing systems 280-288 to modify offerings of the product(s) via an associated website or inventory control system, such as by automatically generating a new bulk/bundled sale entry in the system with corresponding temporal information as to when the price and quantity of the product(s) will be changed and what they will be changed to.

As noted above, the AI pipeline 210 comprises a plurality of AI computer models 211-217 which are trained through machine learning processes to make predictions based on patterns in input data, such as customer/product data. In a first AI computer model 211 of the AI pipeline, the illustrative embodiments predict product units to be sold in inventory and provide bundling optimization. That is, based on available products in a retailer facility, as determined through interfacing with inventory control computing systems of the retailer and using unique product identifiers, such as SKUs and the like, the first AI computer model 211 predicts which product units out of available inventory should be sold in bulk and which products can be sold individually so that, aggregated profit with the product inventory, i.e., across all products in the retailer's inventory, is maximized. The first AI computer model 211 predicts the units to be sold in inventory based on input data specifying the products available in the retailer's inventory, the sales price of the products, the cost of the products, the number of products available in the inventory, and the demand for the products.

In a second AI computer model 212, the size and product mix for a bundle is predicted and a recommended price of each bundle of products, number of each product in the bundle, etc. are determined so as to identify the size and product mix that results in the bulk products being sold within a shortest possible time while maximizing profitability. The second AI computer model 212 receives input data which may include the size of the bundle, the product mix in the bundle, the price of each product in the bundle, and the number of each product in the bundle.

A third AI computer model 213 operates to generate the various sizes of bulk packaging and dynamically determines the different levels of bulk size, e.g., 9 products, 20 products, etc., for different clusters of customers Based on the predicted customer base. In order to generate the various sizes of bulk packaging, the third AI computer model 213 receives data on the customer clusters and the predicted customer base, as well as the types of products being packaged and the quantities of each product.

A fourth AI computer model 214 operates to determine when to initiate the bulk packaging process. That is, based on historical learning, the fourth AI computer model 214 identifies when the bulk selling of different products is to be initiated, where different levels of bulk size can be initiated at different points in time for the same product or combination of products. For example, the fourth AI computer model 214 may determine when to change a bulk size from 9 products to 90 products. In order to make such determinations, the fourth AI computer model 214 operates on a list of products that are eligible for bulk packaging, the quantity of each product that is required for bulk packaging, and the timeframe in which the bulk packaging process should be initiated.

A fifth AI computer model 215 operates to perform social collaboration propagation for bulk processing. That is, based on identified different levels of bulk size for the same or different types of products in each bundle, the fifth AI computer model 215 dynamically propagates the bulk size availability in social networking websites and creates a temporary social network channel so that the bulk sale of products can be sold quickly with the help of the creation of temporary social networking content.

A sixth AI computer model 216 operates to generate predictions regarding mixing and matching of products in bulk or bundles so as to achieve an aggregate volume growth. That is, the sixth AI computer model 216 predicts if bulk products can be associated with individual products so that both the individual products and different level of bulk products can be sold together, while ensuring maximum profit with the identified context. The sixth AI computer model 216 operates on individual product sales data, bulk product sales data, and product association data.

A seventh AI computer model 217 operates to generate a level of interest estimation and predicts this level of interest of customers to buy bulk products. The seventh AI computer model 217 further operates to identify an appropriate supply chain route so that bulk products can be sold within a shortest possible time. The seventh AI computer model 217 operates on such input data as product type, supply chain route information, and customer level of interest as defined by daily hits from social media, for example.

The AI computer models 211-217 together make up the AI pipeline 210 of an AI based product inventory management system. The AI computer models 211-217 generate predictions and classifications for products, specifically with regard to bundling products for bulk sales, so as to maximize movement of products from inventory while also maximizing profits to the suppliers and retailers. The AI pipeline 210 provides one or more outputs to the product bulk/bundle recommendation engine 220 which uses these outputs as input to the various stage logic 221-226 which generate determinations and recommendations that are combined into a product bulk/bundle recommendation output, such as dashboard user interfaces and the like, to provide decision support information to users, e.g., subject matter experts (SMEs), so that they can make decisions regarding bulk/bundled sales opportunities and initiate operations to take advantage of such opportunities. In some illustrative embodiments, automated processes may be automatically initiated to facilitate such bulk/bundled sales including creation of social networking channels, social networking content, and distribution of such content to social networking websites for promoting such bulk/bundled sales, as well as scheduling quantity and price changes in inventory control systems, website content control computing systems, or the like.

Thus, the illustrative embodiments provide an improved artificial intelligence computer system that determines product bulk/bundled sales opportunities for product providers and customers. The AI based inventory management system 200 predicts which product units out of available inventory can be created as a bulk sale opportunities versus sold separately. The AI based inventory management system 200 identifies what should be the bulk size and product mix (units from the inventory) to recommend the price of each set of bulk product units in a shortest amount of time to maximize profits. The AI based inventory management system 200 recommends/creates bulk size based on customer base, interests, type of products, and patterns of previous purchases. The prediction of units to be sold in bulk, bulk size is dynamic based on how soon the inventory should be sold out based on inventory attributes. The AI based inventory management system 200 dynamically propagates the bulk combination(s) and availability by creating a temporary social network channel to market and sell the bulk quickly.

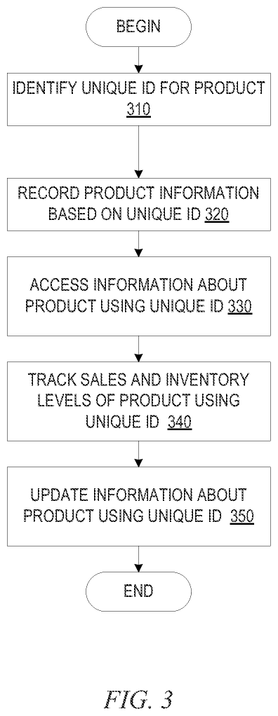

FIGS. 3-8 present flowcharts outlining example operations of elements of the present invention with regard to one or more illustrative embodiments. It should be appreciated that the operations outlined in FIGS. 3-8 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIGS. 3-9, and may, in some cases, make use of the results generated as a consequence of the operations set forth in FIGS. 3-8, the operations in FIGS. 3-8 themselves are specifically performed by the improved computing tool in an automated manner.

FIG. 3 is a flowchart outlining an operation of first stage logic of a product bulk/bundle recommendation engine based on predictions/classifications from AI computer models in accordance with one illustrative embodiment. In a first operation, the first stage logic 221 identifies a unique identifier for each product (step 310). This can be a stock-keeping unit (SKU), a lot number, or any other unique identifier that can be used to identify the product. For example, a manufacturer may assign a SKU to each product they produce, while a retailer may assign a lot number to each item they stock.

The price of the product and any other relevant information, such as expiration date, best use date, etc. are recorded (step 320). This information is stored in a secure database in order to protect the product's information. The product identifier is used consistently across all related subsystems and processes of the AI based inventor management system. This ensures that the product can be identified accurately and quickly. The product identifier is used to access information (step 330) about the product, such as price, expiration date, best use date, etc. and to track sales and inventory levels of the product (step 340). This helps to ensure that the product is in stock and the correct amount is ordered when needed. The product identifier is also used to update information about the product, such as price, expiration date, best use date, etc. (step 350). This helps to ensure that the product's information is always up to date.

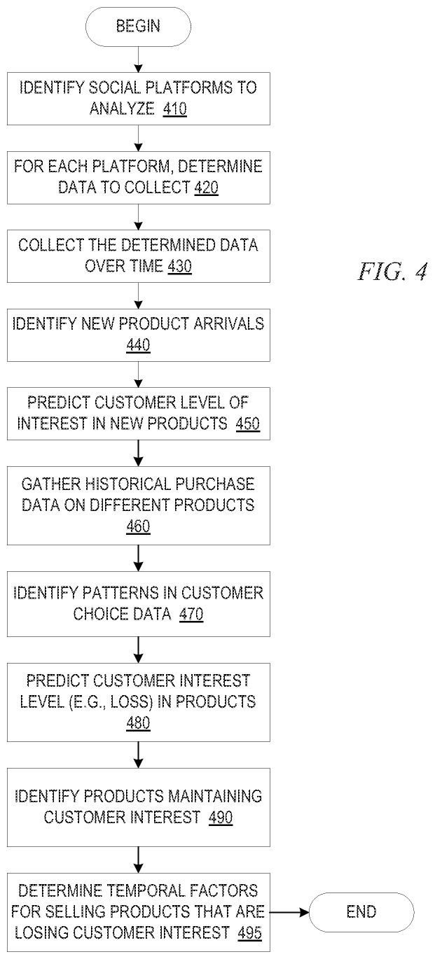

FIG. 4 is a flowchart outlining an operation of second stage logic of a product bulk/bundle recommendation engine based on predictions/classifications from AI computer models in accordance with one illustrative embodiment. In a first operation, the second stage logic identifies social media platforms to analyze (step 410). This can include popular platforms such as Twitter, Facebook, and Instagram, for example, or any other social media, networking, or collaboration platform. This helps to gain insight into customer preferences and trends.

For each platform, the second stage logic determines what data to collect (step 420). This can include customer comments, reviews, likes, and dislikes. This helps to gain a better understanding of customer sentiment.

The second stage logic collects data on customer choice over time (step 430). This helps to identify any changes in customer preference. This data can be used to track customer trends over time.

The second stage logic identifies any new product arrivals (step 440). This helps to see how customer interest is changing. This data can be used to determine which products to stock and promote.

The second stage logic, based on historical learning, predicts customer level of interest in new products (step 450). This helps to determine whether or not the product should be stocked in the store. This data can be used to plan for future stock levels.

The second stage logic gathers historical purchase data on different products (step 460). This helps to identify any patterns in customer choice. This data can be used to determine which products customers prefer.

The second stage logic analyzes data to identify patterns in customer choice (step 470). This helps to identify products that customers are likely to purchase. This data can be used to plan promotions and discounts.

The second stage logic, based on historical learning, predicts when customers will lose interest in certain products (step 480). This helps to determine when to discontinue a product. This data can be used to plan for future stock levels.

The second stage logic identifies which products will maintain customer interest (step 490). This helps to determine which products should be stocked in the store. This data can be used to plan for future stock levels.

The second stage logic, based on historical learning, determines how much time will be needed to sell products that are losing customer interest (step 495). This helps to determine how quickly the product should be sold. This data can be used to plan for future stock levels.

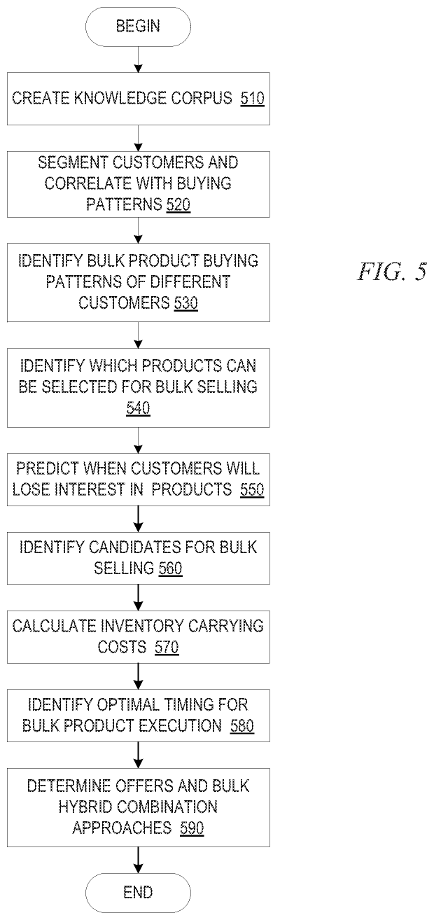

FIG. 5 is a flowchart outlining an operation of third stage logic of a product bulk/bundle recommendation engine based on predictions/classifications from AI computer models in accordance with one illustrative embodiment. As shown in FIG. 5, the third stage logic creates a knowledge corpus based on historical learning (step 510). This corpus includes data on the customer's buying patterns, the growing or waning interest in certain products, and the customer's choice of products. For example, the AI based inventory management system tracks the buying patterns of customers across product categories and identify which products are most in demand.

The third stage logic segments customers and correlates customer segments with buying patterns (step 520). This data is used to identify which customers are more likely to buy products in bulk. For example, the third stage logic may identify that customers in a certain geographic region or with a certain income level are more likely to buy in bulk.

The third stage logic identifies bulk product buying patterns of different customers (step 530). This information is used to determine which products are more likely to be bought in bulk and which customers are more likely to buy these products. For example, the system may identify that customers in a certain region tend to buy certain products in large quantities.

The third stage logic analyzes data to identify which products can be selected for bulk selling (step 540). This helps businesses save money on inventory costs. For example, the system may identify that certain products are more likely to be bought in bulk than others.

The third stage logic identifies when customers will lose interest in a product (step 550). This helps businesses know when to discontinue a product. For example, the system may identify that customers in a certain region are losing interest in a certain product and may recommend that it be discontinued.

The third stage logic uses this information to identify candidates for bulk selling (step 560). This helps businesses save money on inventory costs. For example, the system may identify that certain products are more likely to be bought in bulk and may recommend that they be packaged together for a bulk sale.

The third stage logic calculates the inventory carrying cost (step 570). This helps businesses know how much it costs to carry inventory over time. For example, the system may track the cost of carrying inventory for a certain product over a period of time. The system will include expiration dates and spoilage rates in the carrying cost calculation. This helps businesses keep track of when products expire and how much inventory they are losing to spoilage. For example, the system may track the expiration date of certain products and identify the rate at which they spoil.

The third stage logic identifies the optimal timing for bulk product execution (step 580). This helps businesses know when to execute a bulk sale and which products should be included in the sale. For example, the system may track customer interest in certain products and recommend when to execute a bulk sale.

The third stage logic uses the analysis to determine offers and bulk hybrid combination approaches (step 590). This helps businesses know which products to include in a bulk sale and which products to offer as individual products. For example, the system may identify which products are more likely to be bought in bulk and which should be offered as individual products.

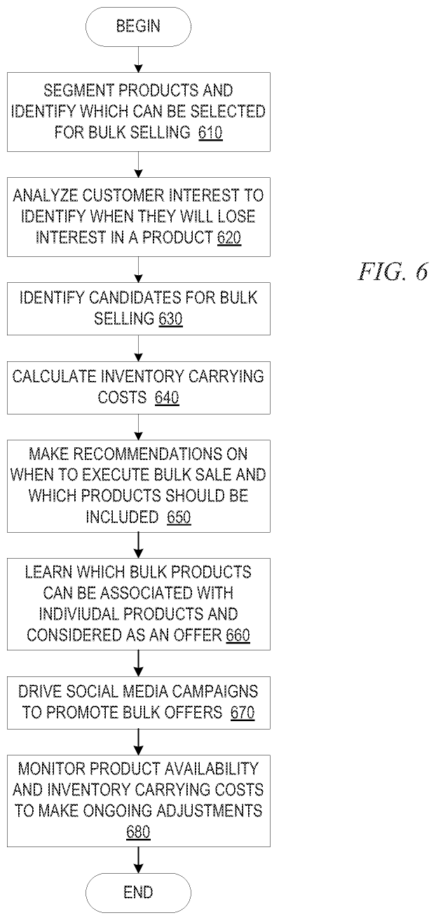

FIG. 6 is a flowchart outlining an operation of fourth stage logic of a product bulk/bundle recommendation engine based on predictions/classifications from AI computer models in accordance with one illustrative embodiment. As shown in FIG. 6, the fourth stage logic segments products and identifies which can be selected for bulk selling (step 610). This involves, for example, analyzing customer purchase patterns and trends to determine which products and customers are more likely to buy in bulk, and which items are best suited for bulk sales. For example, a grocery store may identify that customers buy large quantities of canned vegetables in bulk, so they may offer a discount for customers who purchase a certain amount of cans.

The fourth stage logic analyzes customer interest to identify when they will lose interest in a product (step 620). This involves, for example, studying customer purchase patterns and trends over time to determine when customer interest in a product is waning and they are likely to lose interest. For example, a clothing store may identify that customer interest in a certain type of shirt is declining, and so they may decide to discontinue selling it.

The fourth stage logic uses this information to identify candidates for bulk selling (step 630). This involves, for example, using the information from the previous step to determine which products should be offered for bulk sales. For example, a toy store may identify that certain action figures are popular and have a high likelihood of being bought in bulk, so they may offer discounts for customers who purchase a certain amount of figures.

The fourth stage logic calculates the inventory carrying cost (step 640). This involves, for example, calculating the costs associated with carrying inventory, such as storage costs, labor costs, and other expenses. For example, a furniture store may calculate the cost of storing furniture, including the cost of labor to move furniture around, in order to determine the cost of carrying inventory over time. The fourth stage logic may include expiration dates and spoilage rates in the carrying cost calculation. This will involve taking into account expiration dates and spoilage rates when calculating the inventory carrying cost. For example, a grocery store may include the cost of food that has expired or been spoiled in the calculation of their inventory carrying cost.

The fourth stage logic uses historical data to make recommendations on when to execute a bulk sale, and which products should be included in the sale (step 650). This involves, for example, analyzing customer purchase patterns and trends over time to determine when a bulk sale should occur, and which products should be included in the sale. For example, a shoe store may analyze customer purchase patterns to determine when a bulk sale should occur, and which products should be included in the sale.

The fourth stage logic looks at historical data to learn which bulk products can be associated with any individual product and is considered as an offer (step 660). This involves, for example, studying customer purchase patterns and trends to determine which products can be bundled together and offered as a package deal. For example, a beauty store may offer a bundle of hair care products at a discounted rate.

This information is used by the fourth stage logic to drive social media campaigns to promote the new bulk offers (step 670). This involves, for example, using social media to advertise the bulk offers and reach potential customers. For example, a bookstore may use Twitter to advertise a bundle of books at a discounted rate.

Finally, the fourth stage logic continuously monitors product availability and inventory carrying cost to make ongoing adjustments to the bulk offer updates to ensure profitability (step 680). This involves, for example, monitoring product availability and inventory carrying cost to ensure that the bulk offers remain profitable. For example, a toy store may constantly monitor their inventory carrying cost to ensure that the bulk offers they are offering remain profitable.

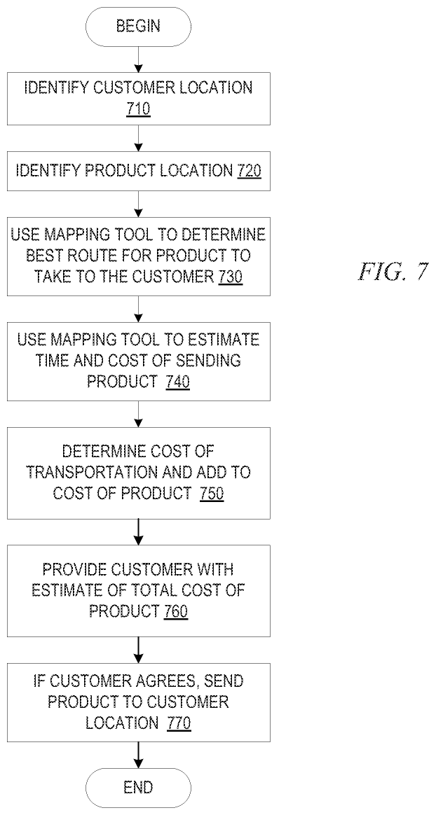

FIG. 7 is a flowchart outlining an operation of fifth stage logic of a product bulk/bundle recommendation engine based on predictions/classifications from AI computer models in accordance with one illustrative embodiment. As shown in FIG. 7, the fifth stage logic identifies the customer's location by gathering information such as their address, zip code, or geographic coordinates (step 710). For example, if the customer provides their address, the system can use an address lookup service to find the corresponding geographic coordinates.

The fifth stage logic identifies the location of the product by gathering information such as the store's address, zip code, or geographic coordinates (step 720). For example, if the store has provided its address, the system can use an address lookup service to find the corresponding geographic coordinates.

The fifth stage logic uses a mapping tool to determine the best route for the product to take to the customer (step 730). The fifth stage logic can use a mapping service to calculate the distance between the customer's location and the store's location, as well as the estimated time and cost of sending the product.

The fifth stage logic uses the mapping tool to determine the estimated time and cost of sending the product (step 740). The fifth stage logic can use the mapping service to estimate the time and cost of sending the product to the customer's location.

The fifth stage logic calculates the cost of the transportation and adds it to the cost of the product (step 750). The fifth stage logic can calculate the cost of the transportation based on the estimated time and cost provided by the mapping service. This cost can then be added to the cost of the product.

The fifth stage logic provides the customer with an estimate of the total cost of the product, including transportation (step 760). The system can provide the customer with an estimate of the total cost of the product, including the transportation cost. If the customer agrees, the product may be sent to the customer's location (step 770).

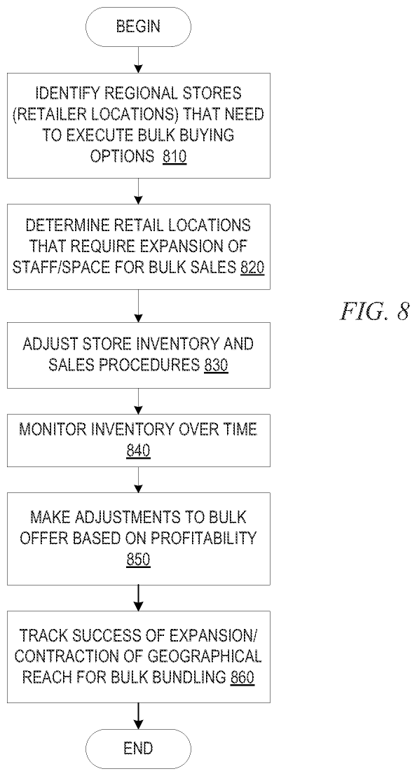

FIG. 8 is a flowchart outlining an operation of sixth stage logic of a product bulk/bundle recommendation engine based on predictions/classifications from AI computer models in accordance with one illustrative embodiment. As shown in FIG. 8, the sixth stage logic identifies the regional stores that need to execute bulk buying options to push inventory at a lower price due to excessive amounts of product (step 810). For example, the region stores in New Mexico may have an excessive amount of product with a fast-approaching expiration date, and therefore need to expand their processing requirements for bulk processing. This operation takes into account the inventory levels, expiration dates, and processing requirements for each store. This data is collected and monitored regularly to ensure that the store's inventories are within acceptable levels.

The sixth stage logic determines retail locations that require expansion of bulk processing, hiring of additional staff, and expansion of the space for processing (step 820). This helps the store to manage the additional product that is being processed.

For retail locations that require reduction of bulk processing, the sixth stage logic adjusts the store's inventory and sales procedures accordingly (step 830). This helps the store to maintain their inventories and make sure that the sales prices remain within acceptable means.

The sixth stage logic monitors the inventories over time to make sure they are within acceptable levels (step 840). This helps the store to ensure that their inventories do not become excessive or deficient.

The sixth stage logic makes adjustments to the bulk offer updates to ensure profitability (step 850). This helps the store to maximize the profits from their bulk processing.

The sixth stage logic tracks the success of the expansion and contraction of the geographical reach for bulk bundling (step 860). This helps the store to identify patterns in their customer's buying behavior and adjust their bulk processing accordingly.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides artificial intelligence mechanisms, such as artificial intelligence pipelines and machine learning trained computer models that perform historical learning, to identify bulk/bundled sales opportunities for one or more products based on evaluations of customer behavior and making predictions about future customer behavior. The improved computing tool implements mechanism and functionality, such as the AI based product inventory management system 200, which cannot be practically performed by human beings either outside of, or with the assistance of, a technical environment, such as a mental process or the like.

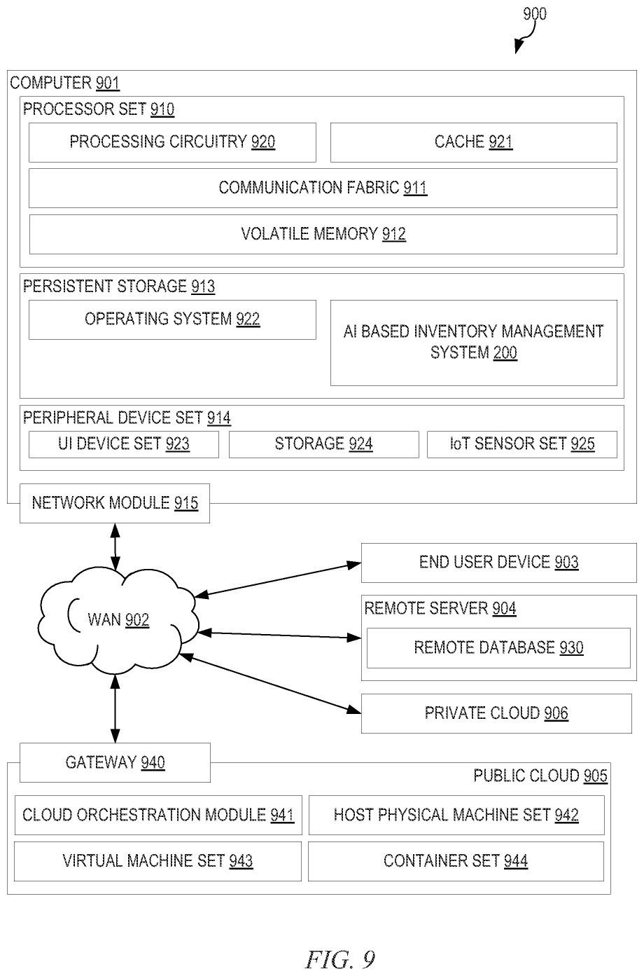

FIG. 9 is an example diagram of a distributed data processing system environment in which aspects of the illustrative embodiments may be implemented and at least some of the computer code involved in performing the inventive methods may be executed. That is, computing environment 900 contains an example of an environment for the execution of at least some of the computer code involved in performing the inventive methods, such as AI based product inventory management system 200. In addition to block 200, computing environment 900 includes, for example, computer 901, wide area network (WAN) 902, end user device (EUD) 903, remote server 904, public cloud 905, and private cloud 906. In this embodiment, computer 901 includes processor set 910 (including processing circuitry 920 and cache 921), communication fabric 911, volatile memory 912, persistent storage 913 (including operating system 922 and block 200, as identified above), peripheral device set 914 (including user interface (UI), device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

Computer 901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically computer 901, to keep the presentation as simple as possible. Computer 901 may be located in a cloud, even though it is not shown in a cloud in FIG. 9. On the other hand, computer 901 is not required to be in a cloud except to any extent as may be affirmatively indicated.

Processor set 910 includes one, or more, computer processors of any type now known or to be developed in the future. Processing circuitry 920 may be distributed over multiple packages, for example, multiple, coordinated integrated circuit chips. Processing circuitry 920 may implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set may be located “off chip.” In some computing environments, processor set 910 may be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 921 and the other storage media discussed below. The program instructions, and associated data, are accessed by processor set 910 to control and direct performance of the inventive methods. In computing environment 900, at least some of the instructions for performing the inventive methods may be stored in block 200 in persistent storage 913.

Communication fabric 911 is the signal conduction paths that allow the various components of computer 901 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 912 is any type of volatile memory now known or to be developed in the future. Examples include dynamic type random access memory (RAM) or static type RAM. Typically, the volatile memory is characterized by random access, but this is not required unless affirmatively indicated. In computer 901, the volatile memory 912 is located in a single package and is internal to computer 901, but, alternatively or additionally, the volatile memory may be distributed over multiple packages and/or located externally with respect to computer 901.

Persistent storage 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 may be a read only memory (ROM), but typically at least a portion of the persistent storage allows writing of data, deletion of data and re-writing of data. Some familiar forms of persistent storage include magnetic disks and solid state storage devices. Operating system 922 may take several forms, such as various known proprietary operating systems or open source Portable Operating System Interface type operating systems that employ a kernel. The code included in block 200 typically includes at least some of the computer code involved in performing the inventive methods.

Peripheral device set 914 includes the set of peripheral devices of computer 901. Data communication connections between the peripheral devices and the other components of computer 901 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 923 may include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 may be persistent and/or volatile. In some embodiments, storage 924 may take the form of a quantum computing storage device for storing data in the form of qubits. In embodiments where computer 901 is required to have a large amount of storage (for example, where computer 901 locally stores and manages a large database) then this storage may be provided by peripheral storage devices designed for storing very large amounts of data, such as a storage area network (SAN) that is shared by multiple, geographically distributed computers. IoT sensor set 925 is made up of sensors that can be used in Internet of Things applications. For example, one sensor may be a thermometer and another sensor may be a motion detector.

Network module 915 is the collection of computer software, hardware, and firmware that allows computer 901 to communicate with other computers through WAN 902. Network module 915 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (for example, embodiments that utilize software-defined networking (SDN)), the control functions and the forwarding functions of network module 915 are performed on physically separate devices, such that the control functions manage several different network hardware devices. Computer readable program instructions for performing the inventive methods can typically be downloaded to computer 901 from an external computer or external storage device through a network adapter card or network interface included in network module 915.

WAN 902 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 903 is any computer system that is used and controlled by an end user (for example, a customer of an enterprise that operates computer 901), and may take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In some embodiments, EUD 903 may be a client device, such as thin client, heavy client, mainframe computer, desktop computer and so on.

Remote server 904 is any computer system that serves at least some data and/or functionality to computer 901. Remote server 904 may be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data may be provided to computer 901 from remote database 930 of remote server 904.

Public cloud 905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs may be stored as images and may be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware, and firmware that allows public cloud 905 to communicate through WAN 902.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 906 is similar to public cloud 905, except that the computing resources are only available for use by a single enterprise. While private cloud 906 is depicted as being in communication with WAN 902, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud.

Thus, the illustrative embodiments provide mechanisms for automatically performing artificial intelligence based inventory management so as to optimize product sales from inventory with regard to bulk/bundled sales opportunities and maximize profits for product suppliers/retailers. The AI mechanisms of the illustrative embodiments provide decision support capabilities based on a complex analysis of a large number of characteristics and factors regarding products, customers, and historical temporal factors. The AI mechanisms leverage data gathered from social networking sources to determine customer interest and purchase behaviors that are used as a basis for predicting customer interest in the products and/or new products so as to identify possible bulk/bundled sales opportunities that move products from inventory expeditiously and with maximization of profits to suppliers and retailers.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for bulk product processing, comprising:
obtaining, from at least one product provider computing system, product data specifying characteristics of at least one product;
obtaining, from at least one social media computing system, customer data specifying customer choice characteristics of one or more customers, with regard to purchasing products as indicated in electronic communications associated with the one or more customers;
creating a knowledge corpus based on a historical learning analysis of the product data and customer data, wherein the knowledge corpus comprises data specifying customer buying patterns, patterns in growing or waning customer interest in products, and patterns in customer choice of products for purchase;
executing, by an artificial intelligence (AI) computer pipeline comprising a plurality of machine learning trained AI computer models, at least one AI computer model, of the plurality of machine learning trained AI computer models, on the knowledge corpus to predict, for a customer segment of the customer data, at least one product that customers of the customer segment are predicted to purchase in bulk;
generating a bulk product recommendation based on results of executing the at least one AI computer model, wherein the bulk product recommendation specifies the at least one product to be sold in bulk; and
outputting the bulk product recommendation to a product provider computing system.

2. The computer-implemented method of claim 1, wherein executing the at least one AI computer model comprises dynamically predicting, based on historical learning applied by the at least one AI computer model, when to initiate processing of bulk purchases of the at least one product and an amount of each product in the at least one product to include in the bulk purchase, at least based on a predicted business impact of the customer interest trends for the customer segment, a current inventory of the at least one product, a current inventory carrying cost of the at least one product, and product expiration dates of the current inventory of the at least one product, and wherein the bulk product recommendation specifies when to initiate processing of bulk purchase of the at least one product and the amount of each product in the at least one product to include in the bulk purchase.

3. The computer-implemented method of claim 1, wherein generating the bulk product recommendation comprises determining one or more optimal supply chain routes based on a predicted level of customer interest in bulk purchases.

4. The computer-implemented method of claim 1, wherein outputting the bulk product recommendation comprises automatically driving a social media campaign promoting a bulk sale of the at least one product to customers corresponding to the one or more selected customers.

5. The computer-implemented method of claim 1, wherein executing the at least one AI computer model comprises executing a customer interest level AI computer model that applies historical learning to the customer data to predict a customer interest trend with regard to the at least one product.

6. The computer-implemented method of claim 1, wherein executing the at least one AI computer model comprises executing a customer interest level AI computer model that predicts a customer interest trend in new products based on the customer data collected from the at least one social media computing system.

7. The computer-implemented method of claim 1, wherein executing the at least one AI computer model comprises executing a customer interest level AI computer model that predicts which products, in a plurality of products comprising the at least one product, will maintain a customer interest level over time.

8. The computer-implemented method of claim 1, wherein executing the at least one AI computer model comprises executing a customer interest level AI computer model that predicts which products, in a plurality of products comprising the at least one product, are losing customer interest over time.

9. The computer-implemented method of claim 8, wherein the customer interest level AI computer model further predicts, for a product provider, an amount of time needed to sell products that are losing customer interest over time based on a current inventory level of the product at the product provider and a trend in number of sales of the product over time.

10. The computer-implemented method of claim 1, wherein creating the knowledge corpus comprises segmenting customers and correlating customer segments with product purchasing patterns to thereby identify which customers are more likely to purchase particular products in bulk and which products are more likely to be bought by customers of the customer segment in bulk.

11. A computer program product comprising a computer readable storage medium having a computer readable program stored therein, wherein the computer readable program, when executed on a computing device, causes the computing device to:
obtain, from at least one product provider computing system, product data specifying characteristics of at least one product;
obtain, from at least one social media computing system, customer data specifying customer choice characteristics of one or more customers, with regard to purchasing products as indicated in electronic communications associated with the one or more customers;
create a knowledge corpus based on a historical learning analysis of the product data and customer data, wherein the knowledge corpus comprises data specifying customer buying patterns, patterns in growing or waning customer interest in products, and patterns in customer choice of products for purchase;
execute, by an artificial intelligence (AI) computer pipeline comprising a plurality of machine learning trained AI computer models, at least one AI computer model, of the plurality of machine learning trained AI computer models, on the knowledge corpus to predict, for a customer segment of the customer data, at least one product that customers of the customer segment are predicted to purchase in bulk;
generate a bulk product recommendation based on results of executing the at least one AI computer model, wherein the bulk product recommendation specifies the at least one product to be sold in bulk; and
output the bulk product recommendation to a product provider computing system.

12. The computer program product of claim 11, wherein executing the at least one AI computer model comprises dynamically predicting, based on historical learning applied by the at least one AI computer model, when to initiate processing of bulk purchases of the at least one product and an amount of each product in the at least one product to include in the bulk purchase, at least based on a predicted business impact of the customer interest trends for the customer segment, a current inventory of the at least one product, a current inventory carrying cost of the at least one product, and product expiration dates of the current inventory of the at least one product, and wherein the bulk product recommendation specifies when to initiate processing of bulk purchase of the at least one product and the amount of each product in the at least one product to include in the bulk purchase.

13. The computer program product of claim 11, wherein generating the bulk product recommendation comprises determining one or more optimal supply chain routes based on a predicted level of customer interest in bulk purchases.

14. The computer program product of claim 11, wherein outputting the bulk product recommendation comprises automatically driving a social media campaign promoting a bulk sale of the at least one product to customers corresponding to the one or more selected customers.

15. The computer program product of claim 11, wherein executing the at least one AI computer model comprises executing a customer interest level AI computer model that applies historical learning to the customer data to predict a customer interest trend with regard to the at least one product.

16. The computer program product of claim 11, wherein executing the at least one AI computer model comprises executing a customer interest level AI computer model that predicts a customer interest trend in new products based on the customer data collected from the at least one social media computing system.

17. The computer program product of claim 11, wherein executing the at least one AI computer model comprises executing a customer interest level AI computer model that predicts which products, in a plurality of products comprising the at least one product, will maintain a customer interest level over time.

18. The computer program product of claim 11, wherein executing the at least one AI computer model comprises executing a customer interest level AI computer model that predicts which products, in a plurality of products comprising the at least one product, are losing customer interest over time.

19. The computer program product of claim 18, wherein the customer interest level AI computer model further predicts, for a product provider, an amount of time needed to sell products that are losing customer interest over time based on a current inventory level of the product at the product provider and a trend in number of sales of the product over time.

20. An apparatus comprising:
at least one processor; and
at least one memory coupled to the at least one processor, wherein the at least one memory comprises instructions which, when executed by the at least one processor, cause the at least one processor to:
obtain, from at least one product provider computing system, product data specifying characteristics of at least one product;
obtain, from at least one social media computing system, customer data specifying customer choice characteristics of one or more customers, with regard to purchasing products as indicated in electronic communications associated with the one or more customers;
create a knowledge corpus based on a historical learning analysis of the product data and customer data, wherein the knowledge corpus comprises data specifying customer buying patterns, patterns in growing or waning customer interest in products, and patterns in customer choice of products for purchase;
execute, by an artificial intelligence (AI) computer pipeline comprising a plurality of machine learning trained AI computer models, at least one AI computer model, of the plurality of machine learning trained AI computer models, on the knowledge corpus to predict, for a customer segment of the customer data, at least one product that customers of the customer segment are predicted to purchase in bulk;
generate a bulk product recommendation based on results of executing the at least one AI computer model, wherein the bulk product recommendation specifies the at least one product to be sold in bulk; and
output the bulk product recommendation to a product provider computing system.
